(19) United States
(12) Patent Application Publication
(10) Pub. No.: US 2022/0388416 A1
(43) Pub. Date: Dec. 8, 2022

(54) INFORMATION PROCESSING DEVICE, INFORMATION PROCESSING METHOD, AND INFORMATION SYSTEM

(71) Applicant: TOYOTA JIDOSHA KABUSHIKI KAISHA, Toyota-shi (JP)

(72) Inventors: Yu NAGATA, Tokyo (JP); Toshihiro NAKAMURA, Shizuoka-ken (JP)

(73) Assignee: TOYOTA JIDOSHA KABUSHIKI KAISHA, Toyota-shi (JP)

(21) Appl. No.: 17/710,006

(22) Filed: Mar. 31, 2022

(30) Foreign Application Priority Data
Jun. 4, 2021 (JP) 2021-094563

(51) Int. Cl. B60L 53/62; B60L 53/65; B60L 58/12

(52) U.S. Cl. CPC B60L 53/62; B60L 53/65; B60L 58/12

(57) ABSTRACT

A control unit of an information processing device is configured to perform: acquiring a first amount of charged electric power required for a battery that operates a predetermined device; and selecting a charging method enabling charging with at least the first amount of charged electric power in a period of a first time out of a plurality of charging methods.

### CROSS-REFERENCE TO RELATED APPLICATION

This application claims priority to Japanese Patent Application No. 2021-094563 filed on Jun. 4, 2021, incorporated herein by reference in its entirety.

### BACKGROUND

### 1. Technical Field

The present disclosure relates to an information processing device, an information processing method, and an information system.

### 2. Description of Related Art

Today, various devices that operate with a battery such as a mobile object such as an electric vehicle or a portable information device are being used. For example, Japanese Unexamined Patent Application Publication No. 2011-120327 (JP 2011-120327 A) proposes that batteries be charged based on travel plans of a plurality of vehicles and external factors affecting an amount of electric power used in a battery of each vehicle.

### SUMMARY

An embodiment of the present disclosure is to enable selecting an appropriate charging method according to a situation of a device which is operated by a battery.

An aspect of the present disclosure provides an information processing device. The information processing device includes a control unit configured to perform: acquiring a first amount of charged electric power required for a battery that operates a predetermined device; and selecting a charging method enabling charging with at least the first amount of charged electric power in a period of a first time out of a plurality of charging methods.

Another aspect of the present disclosure provides an information processing method that is performed by a computer. In the information processing method, a computer is configured to perform: acquiring a first amount of charged electric power required for a battery that operates a predetermined device; and selecting a charging method enabling charging with at least the first amount of charged electric power in a period of a first time out of a plurality of charging methods.

Another aspect of the present disclosure provides an information system. The information system includes: an information processing device including a control unit configured to perform acquiring a first amount of charged electric power required for a battery that operates a predetermined device and selecting a charging method enabling charging with at least the first amount of charged electric power in a period of a first time out of a plurality of charging methods; and the predetermined device.

With the information processing device and the like, it is possible to select an appropriate charging method according to a situation of a device which is operated by a battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an information system according to a first embodiment;

FIG. 2 is a diagram illustrating a release note which is transmitted from a vehicle management center to a control center;

FIG. 3 is a diagram illustrating a data example of an operation schedule which is transmitted from the control center to each mobile object;

FIG. 4 is a diagram illustrating state information of mobile objects stored in the control center;

FIG. 5 is a diagram illustrating charging/discharging characteristics of a charging facility and battery which are provided in the information system;

FIG. 6 is a diagram illustrating a process of setting an operation schedule of a mobile object, which is performed by a computer of the control center;

FIG. 7 is a flowchart illustrating details of a process of planning a next operation schedule with an update of a computer program;

FIG. 8 is a flowchart illustrating details of a process of planning a next operation schedule without an update of a computer program;

FIG. 9 is a flowchart illustrating details of a process of planning a next operation schedule with an update according to a second embodiment;

FIG. 10 is a diagram illustrating details of a process of adjusting a scheduled next operation time;

FIG. 11 is a diagram illustrating details of a detailed modification of the process of adjusting a next scheduled operation time;

FIG. 12 is a diagram illustrating a configuration of an information system according to a third embodiment; and

FIG. 13 is a diagram illustrating a process of making a plan for updating a computer program which is executed by a computer of a portable electronic device.

### DETAILED DESCRIPTION OF EMBODIMENTS

Hereinafter, an information processing device, an information processing method, and an information system according to an embodiment will be described with reference to the accompanying drawings. The information processing device includes a control unit configured to perform acquiring a first amount of charged electric power required for a battery that operates a predetermined device and selecting a charging method enabling charging with at least the first amount of charged electric power in a period of a first time out of a plurality of charging methods.

Here, the predetermined device is not particularly limited as long as it is a device or equipment that is operated with a battery. The battery is called a rechargeable secondary battery or a storage battery. The battery is also called a battery. The first amount of charged electric power required for the battery is an amount of charged electric power required for enabling the predetermined device to provide a function to a user after the first time has elapsed. For example, it is preferable that the battery be charged with an amount of electric power for enabling provision of a function such that a plan for use of the predetermined device, a schedule of a user, or the like is not affected through charging with the first amount of charged electric power in the period of the first time.

### First Embodiment

System Configuration

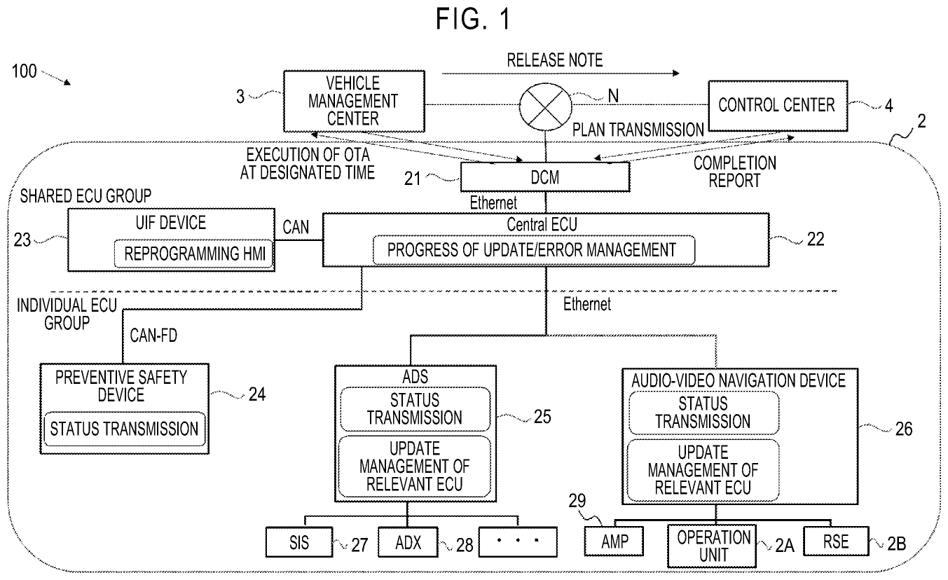

FIG. 1 is a diagram illustrating an information system 100 according to a first embodiment. The information system 100 includes a mobile object 2, a computer of a vehicle management center 3, and a computer of a control center 4. In the following description, the computer of the vehicle management center 3 and the computer of the control center 4 are also simply referred to as the vehicle management center 3 and the control center 4. The mobile object 2, the vehicle management center 3, and the control center 4 are connected to each other via a network N.

The network N includes a wired network and a wireless network. The wired network is, for example, a broadband network such as an optical fiber network which is also referred to as a core network or a backbone. The wireless network includes, for example, a mobile phone network such as a Long Term Evolution (LTE) mobile communication system, a 5th-generation mobile communication system (5G), or a 6th-generation mobile communication system (6G).

The mobile object 2 is, for example, a vehicle. The vehicle may have four wheels, three wheels, or two wheels. The vehicle may be driven by an engine or may be driven by a motor. The vehicle may be a vehicle in which an automated driving system that enables a vehicle to travel autonomously or to move automatically is mounted.

As illustrated in FIG. 1, the mobile object 2 includes a data communication module (DCM) 21, a central electronic control unit (central ECU) 22, a user interface (UIF) device 23, a preventive safety device 24, an advanced drive system (ADS) 25, and an audio-video navigation device 26.

The DCM 21 accesses the network N and communicates with another mobile object, the vehicle management center 3, or the control center 4. The DCM 21 can perform radio communication via the mobile communication network.

The central ECU 22 manages devices in the mobile object 2. The central ECU 22 includes, for example, a processor and a memory. The processor executes a computer program in the memory and performs processes of the central ECU 22. For example, the central ECU 22 updates a computer program which is executed by an ECU provided in each device in the mobile object 2 and manages progress of the update. The central ECU 22 detects an error when the computer program has been updated and performs an error-countermeasure process. A combination of the central ECU 22 and the DCM 21 is an example of a computer that is mounted in a vehicle.

The UIF device 23 provides a user interface, for example, when computer programs which are executed by the ECUs mounted in the devices in the mobile object 2 are updated. The user interface is also referred to as a reprogramming human-machine interface (reprogramming HMI). The UIF device 23 includes an ECU which is the same as the central ECU 22. The central ECU 22, the ECU in the UIF device 23, and the like can be referred to as a shared ECU group.

The preventive safety device 24 has an ECU built thereinto and performs a collision avoidance support process executing a computer program. The preventive safety device 24 performs, for example, support of collision avoidance, notification of lane departure, automatic high beam, and radar cruise control based on signals from sensors such as a radar and a camera.

A spatial information service (SIS) 27, an advanced drive extension (ADX) 28, and the like are connected to the ADS 25. The ADS 25, the SIS 27, and the ADX 28 each have an ECU built thereinto and perform a highly advanced drive support process by executing a computer program. The ADS 25 detects a vehicle or a 3D object near the mobile object 2, for example, based on detection signals from a Light Detection and Ranging (LiDAR), estimates a position of the mobile object 2, and performs movement control.

The SIS 27 provides a posture, a position on a map, and the like of the mobile object 2 to the ADS 25. That is, the SIS 27 acquires position information from a global navigation satellite system (GNSS) or a global positioning system (GPS), acceleration signals of six axes from a gyro sensor, route information or map information from a navigation system, and the like. The SIS 27 calculates the posture, the position on a map, and the like of the mobile object 2 based on the acquired information. The ADX 28 employs an artificial intelligence (AI) system, recognizes information from the aforementioned various sensors or the like, performs processing, and notifies the ADS 25 of the processing results.

A rear seat entertainment (RSE) 2B is connected to the audio-video navigation device 26. The audio-video navigation device 26 and the RSE 2B each have an ECU built thereinto and provide various functions based on sound, video, map information, and the like to a user of the mobile object 2 by executing a computer program.

As illustrated in FIG. 1, for example, an AMP 29 for amplifying a signal and an operation unit 2A can be additionally connected to the audio-video navigation device 26. The operation unit 2A is, for example, a touch display and is configured to display information for a user and to receive an operation from the user. When the mobile object 2 is a vehicle including a rear seat, the RSE 2B independently provides a user sitting on the rear seat with television broadcast, digital versatile disc (DVD) video, and the like in the rear seat of a cabin.

The ECUs of the preventive safety device 24, the ADS 25, and the audio-video navigation device 26 and ECUs of devices connected thereto can be referred to as an individual ECU group. The central ECU 22 manages progress of update of computer programs mounted in the individual ECU group and updating errors.

The vehicle management center 3 is operated by an organization such as a company that sells the mobile object 2 or performs maintenance of the mobile object 2, a company to which the company or the like entrusts tasks, or the like. The vehicle management center 3 manages components such as ECUs mounted in all mobile objects that are sold or maintained by the company or the like. The vehicle management center 3 manages types and versions of computer programs which are executed by the ECUs. The vehicle management center 3 transmits update data for updating a computer program to the mobile object 2 or the like. The update data may be simply referred to as an update program.

The control center 4 manages operation and maintenance of each of the mobile objects 2. The control center 4 is, for example, a computer of a fleet management service (FMS) company that provides an FMS. The control center 4 prepares, for example, an operation schedule including an operation start time, operation, an operation end time, and a maintenance time period of a mobile object 2 which is periodically operated. The control center 4 timely updates the operation schedules, distributes the updated operation schedules to the mobile objects 2, and manages the operation of the mobile objects 2. The control center 4 manages use schedules in sharing including a travel start date and time, a travel end date and time, and a maintenance date and time of each mobile object 2 in a service which is non-periodically used, for example, in a ride sharing service. The control center 4 manages rental schedules of the mobile objects 2 which are used in a rental service. In the following description, schedules of operation, use, and rental of a mobile object 2 are collectively simply referred to as an operation schedule. When a mobile object 2 is a motor-driven vehicle, the control center 4 adds a charging schedule of the mobile object 2 to the operation schedule and manages the resultant operation schedule.

As described above, the mobile object 2 has various components including ECUs mounted therein. Computer programs executed by the ECUs of the components are updated based on improvement or defect-countermeasure. Safety is required for the mobile object 2. Accordingly, updating of computer programs for the ECUs mounted in the mobile object 2 is performed in a maintenance period in which travel of the mobile object 2 is stopped.

The vehicle management center 3 transmits newest update details and update schedules for the computer programs of the ECUs in the form of a release note to the control center 4. When the release note is received, the control center 4 adds the update schedules of the computer programs of the ECUs to the operation schedules of each mobile object 2. That is, the control center 4 plans an operation schedule of each mobile object 2 such that updating of computer programs of the ECUs is completed in a maintenance period in which the mobile object 2 is not traveling. The control center 4 notifies the corresponding mobile object 2 of the planned operation schedule (plan transmission in FIG. 1) and causes the mobile object to perform updating the computer programs of the ECUs.

The DCM 21 of the mobile object 2 communicates with the vehicle management center 3 and the control center 4 via the network N. The DCM 21 receives an operation schedule including an update plan of computer programs from the control center 4 (plan transmission in FIG. 1). The central ECU 22 is connected to the DCM 21 via a network in the mobile object such as Ethernet (registered trademark).

The DCM 21 accesses the vehicle management center 3 according to the received operation schedule, acquires update data for updating computer programs, and transmits the update data to the central ECU 22. The central ECU 22 updates the computer programs of the ECUs including the shared ECU group and the individual ECU group in the maintenance period in which the mobile object 2 stops. When updating of the ECUs by the central ECU 22 is completed, the DCM 21 notifies the control center 4 of a completion report.

The UIF device 23 is connected to the central ECU 22 via a network in the mobile object such as controller area network (CAN (registered trademark)). The UIF device 23 may receive an input of confirmation based on a user's operation via the reprogramming HMI. That is, the central ECU 22 may request a user to confirm updating start of the computer programs using the UIF device 23 and start the updating after the confirmation has been performed. The UIF device 23 itself acquires update data from the central ECU 22 and updates computer programs of the UIF device 23.

The preventive safety device 24 is connected to the central ECU 22 via a network in the mobile object 2 such as controller area network with flexible data rate (CAN-FD (CAN is a registered trademark)). The preventive safety device 24 receives update data of computer programs from the central ECU 22 and performs updating. Then, the preventive safety device 24 reports a status based on the updating to the central ECU 22.

The ADS 25 and the audio-video navigation device 26 are connected to the central ECU 22 via a network in the mobile object such as Ethernet (registered trademark). The ADS 25 and the audio-video navigation device 26 receive update data of computer programs from the central ECU 22. The ADS 25 and the audio-video navigation device 26 perform updating of computer programs of ECUs of themselves and a load. The ADS 25 and the audio-video navigation device 26 reports a status based on the updating to the central ECU 22.

Example of Data

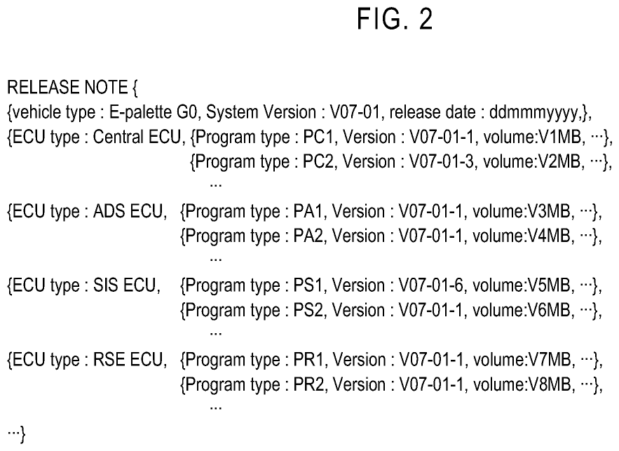

FIG. 2 illustrates an example of a release note which is transmitted from the vehicle management center 3 to the control center 4. In the example illustrated in FIG. 2, a value for a keyword is designated in the form of “keyword: value” in the release note. In the example illustrated in FIG. 2, groups of “keyword: value” are enclosed with curly brackets “{ }” and are hierarchically described.

That is, it can be seen from FIG. 2 that it is a release note of a computer program in which a vehicle type of a mobile object 2 is E-palette GO, a system version to be released is V07-01, and a release date is ddmmmyyyy. Here, the system version is a version which is given to the whole computer program group installed in the mobile object 2. In the release note, a type, a version, a data size (a data volume, a volume) of update data, and the like of a program are described for each type of ECU (ECU type). For example, it can be seen that the version of PC1 which is a program for the center ECU is V07-01-1 and the data size thereof is V1 MB.

The release note is not limited to the form illustrated in FIG. 2. For example, the release note may be described in a prescribed format such as Hyper Text Markup Language (HTML) or Extensible Markup Language (XML). The release note may be described in the form of a table in which records including a plurality of elements are arranged.

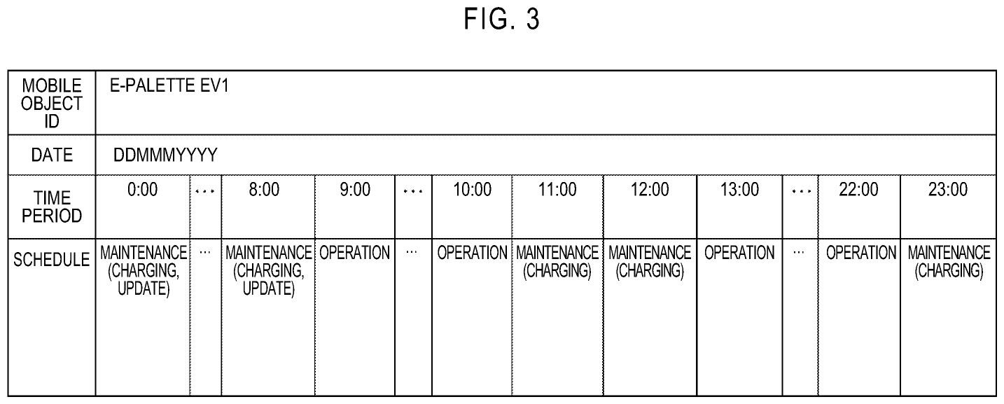

FIG. 3 illustrates a data example of an operation schedule which is transmitted from the control center 4 to each mobile object (which is transmitted by “plan transmission” in FIG. 1). The operation schedule is prepared for each mobile object 2. Accordingly, the operation schedule illustrated in FIG. 3 includes a mobile object ID for identifying a mobile object 2. In the example illustrated in FIG. 3, the operation schedule is prepared every day and thus includes a date. In the example illustrated in FIG. 3, the operation schedule prescribes schedules of operation and maintenance of the mobile object 2 for each time period.

For example, between 0:00 and 9:00 on a date DDMMMYYYY, maintenance of the mobile object 2 is performed. Maintenance includes charging of a battery with a mobile object ID: E-PALETTE EV1 and updating of a computer program. The mobile object with a mobile object ID: E-PALETTE EV1 operates from 9:00 to 11:00. The mobile object with a mobile object ID: E-PALETTE EV1 stops its operation, is subjected to maintenance, and charges its battery from 11:00 to 13:00. The mobile object mobile object with a mobile object ID: E-PALETTE EV1 operates from 13:00 to 23:00 and stops its operation and is subjected to maintenance after 23:00. In the example illustrated in FIG. 3, details of a maintenance schedule and an operation schedule between 13:00 to 22:00 are omitted.

FIG. 3 illustrates only an example of an operation schedule, and the operation schedule prepared by the control center 4 is not limited to the example illustrated in FIG. 3. For example, in FIG. 3, time periods are defined as fineness of one hour. However, the time periods may be defined as fineness of one minute. The operation schedule may not be prepared every day and may be prepared, for example, every week. The operation schedule may be prepared every month. The operation schedule may be prepared every week day (Monday to Friday), every Saturday, and every holiday.

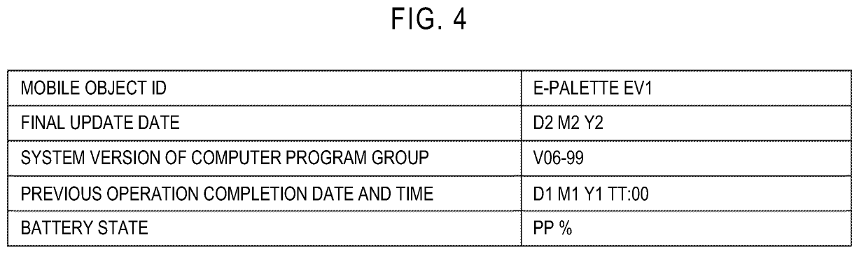

FIG. 4 is a diagram illustrating state information of mobile objects 2 stored in the control center 4. The state information includes a current update state of a computer program and a battery state of each mobile object 2. The state information is stored in a predetermined database of the control center 4. In the example illustrated in FIG. 4, the state information includes a mobile object ID, a final update date, a system version of the whole computer program group installed in the mobile object 2, a previous operation end date and time, and a battery state.

Similarly to FIG. 3, the mobile object ID is identification information for uniquely identifying a mobile object 2. The final update date is an update date on which the mobile object 2 (with a mobile object ID: E-PALETTE EV1 in FIG. 4) has finally updated the computer program group of the ECUs of the constituents thereof. The system version of the computer program group is a version of the whole computer program after it has been updated in the mobile object 2 as described above with reference to FIG. 2.

However, the state information is not limited to such a configuration. For example, the state information may include a current version of each program (a version of a program Version: V07-01-1 in FIG. 2) individually for each ECU of each constituent. The control center 4 records the final update date and time and the system version of the whole updated computer program group on the state information when an update completion report has been received from the mobile object 2.

The previous operation end date and time is a date and time at which the corresponding mobile object 2 (with a mobile object ID: E-PALETTE EV1 in FIG. 4) has completed its previous operation and transmitted a report to the control center. The battery state is a current state of charge (SOC) of the battery. The control center 4 acquires the state of charge of the battery and records the acquired state of charge on the “battery state” of the state information when the operation completion report has been received from the mobile object 2. The state of charge (SOC) of the battery is represented, for example, by a percentage of a ratio of a residual capacity to an amount of electric power in a fully charged state.

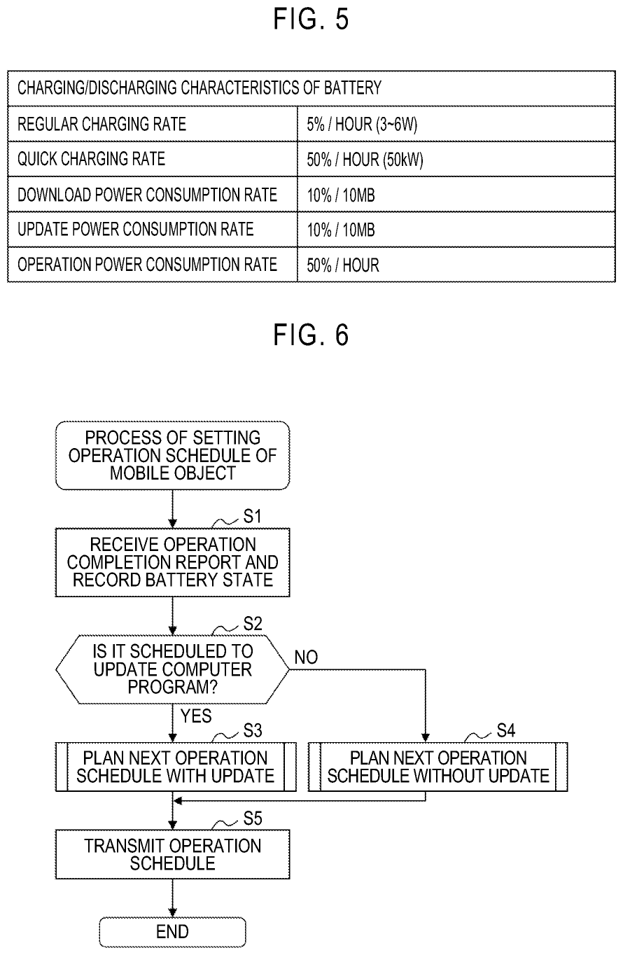

FIG. 5 is a diagram illustrating charging/discharging characteristics of a battery which is stored in the control center 4. Here, the charging/discharging characteristics of a battery also depend on charging facilities provided in the information system 100. In this embodiment, it is assumed that the battery mounted in the mobile object 2 has the charging/discharging characteristics illustrated in FIG. 5. The charging/discharging characteristics can be accumulated experimentally or empirically. In FIG. 5, charging rates of regular charging and quick charging, a download power consumption rate, an update power consumption rate, and an operation power consumption rate are included as the charging/discharging characteristics of the battery.

The charging facilities installed in the information system 100 include facilities that can perform regular charging and facilities that can perform quick charging. Quick charging refers to a charging method of which the charging rate is higher than that of regular charging. In FIG. 5, the charging rate is an amount of charged electric power per hour, and the amount of charged electric power is represented as an SOC (%/hour). First, when regular charging is performed, the battery mounted in the mobile object 2 can be charged with electric power at a rate of 5%/hour. Here, 5%/hour is, for example, 3 kWh to 6 kWh per hour. It means that 20 hours is required up to a fully charged state when the battery is charged at a charging rate of 5%/hour in a state in which the battery is completely discharged.

When quick charging is performed, the battery illustrated in FIG. 5 can be charged with electric power at a rate of 50%/hour. Here, electric power with which the battery is charged at a rate of 50%/hour is, for example, equal to or greater than 50 kWh per hour. That is, the battery illustrated in FIG. 5 can reach a fully charged state in 2 hours from a state in which the battery is completely discharged when the quick charging is performed.

The download power consumption rate is an amount of consumed electric power per predetermined unit of data volume when the DCM 21 of the mobile object 2 performs downloading of update data for a computer program and is represented as an SOC. The download power consumption rate of the battery illustrated in FIG. 5 is 10%/10 MB. That is, the SOC of the battery decreases by 10% whenever data of 10 MB is downloaded.

The update power consumption rate is an amount of consumed electric power per predetermined unit of data volume of update data when the DCM 21 and the ECU group of the central ECU 22 of the mobile object 2 perform updating of a computer program and is represented as an SOC. The update power consumption rate of the battery illustrated in FIG. 5 is 10%/10 MB. That is, the SOC of the battery decreases by 10% whenever updating with update data of 10 MB is performed.

The operation power consumption rate is an amount of consumed electric power per hour when the mobile object 2 operates and is represented as an SOC. The operation power consumption rate of the battery illustrated in FIG. 5 is 50%/hour. That is, the SOC of the battery decreases by 50% with travel of one hour. That is, in the example illustrated in FIG. 5, the mobile object 2 consumes an amount of electric power of the fully charged battery with travel of two hours. The data illustrated in FIG. 5 is only an example, and the batteries of the mobile objects 2 and the charging facilities for charging the batteries are not limited to the example illustrated in FIG. 5. In the following processes, a required amount of charged electric power, a charging time, and the like of a battery are calculated using the charging/discharging characteristics.

The control center 4 may store information of the charging/discharging characteristics of the battery illustrated in FIG. 5 for each vehicle type or for each battery type. The information of the charging/discharging characteristics of a battery is not limited to being stored in the control center 4 and, for example, the central ECU 22 of each mobile object 2 may store the information for a battery mounted in the mobile object 2. In this case, the control center 4 may acquire the information of charging/discharging characteristics of a battery mounted in each mobile object 2 by inquiring of the corresponding mobile object 2.

Flow of Processes

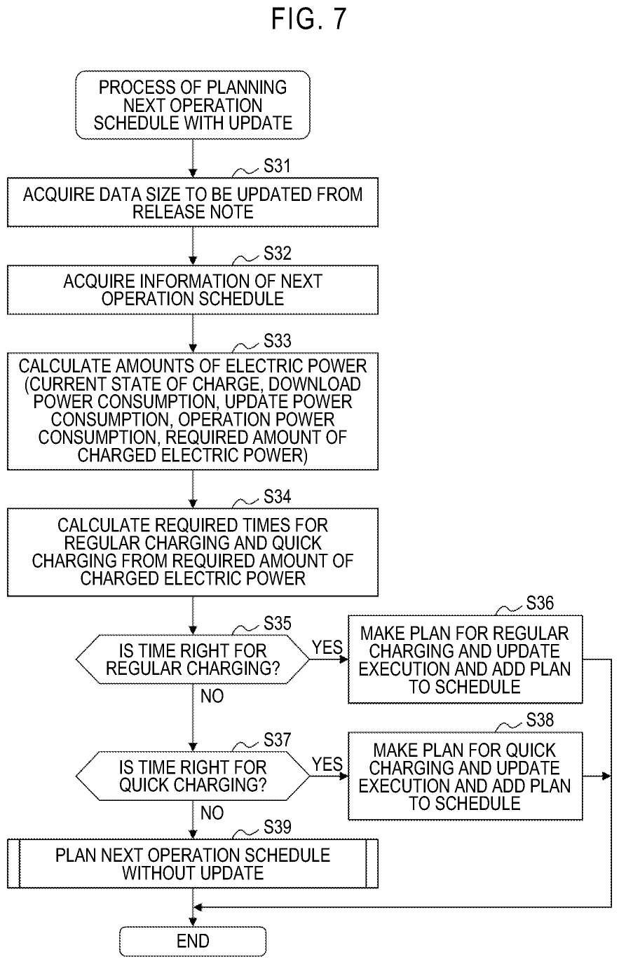

FIG. 6 illustrates a flow of a process of setting an operation schedule of a mobile object 2 which is performed by the computer of the control center 4. As described above, the flow of process illustrated in FIG. 6 will be described below while simply mentioning the computer of the control center 4 as the control center 4. The same is true of FIGS. 7 to 13 and the like. The flow of process illustrated in FIG. 6 is performed, for example, when current operation of a mobile object 2 has been completed. The flow of process illustrated in FIG. 6 is based on the premise that downloading of update data for updating and updating of a computer program of each ECU of the mobile object 2 are performed while the battery of the mobile object 2 is being charged when updating of the computer program is performed.

In the flow of process illustrated in FIG. 6, the control center 4 receives an operation completion report from the mobile object 2. The operation completion report includes the state of charge of the battery of the mobile object 2. Therefore, the control center 4 records the state of charge of the battery of the mobile object 2 on the state information in the predetermined database (see FIG. 4) (51). The operation completion report from the mobile object 2 may be received, for example, when final operation in a daily operation schedule has been completed. The operation completion report from the mobile object 2 may be received whenever operation of the mobile object 2 has been completed. When the operation completion report is received whenever operation of the mobile object 2 has been completed, the control center 4 may correct the operation schedule illustrated in FIG. 3 for each operation completion report.

Then, the control center 4 determines whether it is scheduled to update a computer program in the mobile object 2. The control center 4 compares a newest release note received from the vehicle management center 3 with the state information of the mobile object 2 (FIG. 4). When the system version of the computer program in the mobile object 2 is older than the system version defined in the newest release note, the control center 4 determines that it is scheduled to update a computer program. When it is scheduled to update a computer program, the control center 4 performs a process of planning a next operation schedule with an update (S3). Details of S3 are illustrated in FIG. 7.

When it is not scheduled to update a computer program, the control center 4 performs a process of planning a next operation schedule without an update (S4).

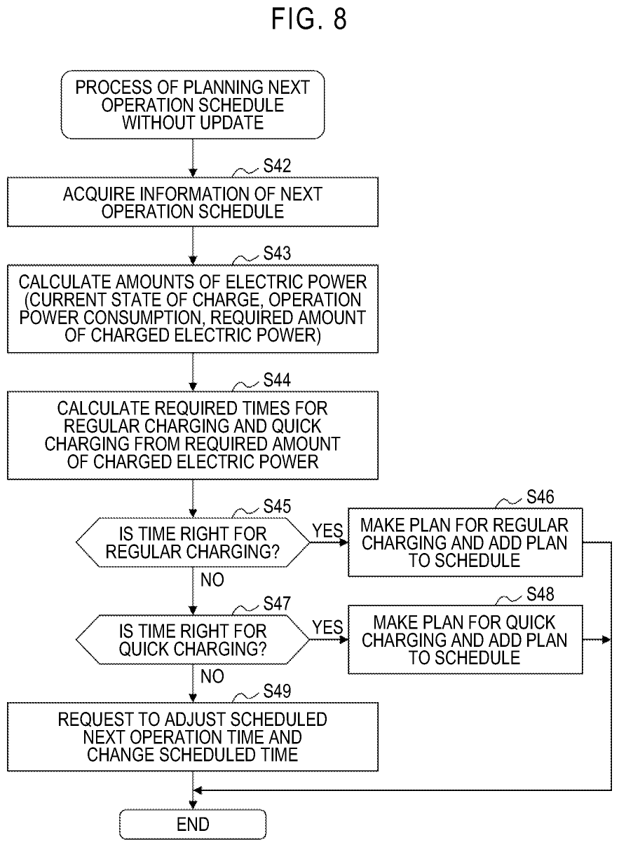

Details of S4 are illustrated in FIG. 8.

Then, the control center 4 transmits the operation schedule to the mobile object 2 (S5). The mobile object 2 operates in accordance with the transmitted operation schedule. The control center 4 receives an update completion report from the mobile object 2 after the updating has been completed. Then, the control center 4 records the updated version and the update date and time on the state information for each mobile object 2. Thereafter, the flow of processes illustrated in FIG. 6 ends.

FIG. 7 is a flowchart illustrating details of the process of planning a next operation schedule with an update (S3 in FIG. 6) of a computer program in the mobile object 2 which his performed by the computer of the control center 4. In this process, the control center 4 makes an update plan for updating the computer programs executed by the ECUs of the mobile object 2 up to a next operation time.

First, in this process, the control center 4 acquires a data size of update data (a value of volume in FIG. 2) from the release note (S31). The release note is an example of information on updating of a first program including a data volume of update data which is used to update the first program. Here, the first program is exemplified as a program group which is rewritten in this update. Accordingly, the control center 4 can be said to perform the process of S31 as an example in which information on updating of the first program is acquired.

The control center 4 acquires information of a next operation schedule (S32). The information of a next operation schedule includes a scheduled next operation start time and a destination, a travel route, and a scheduled travel time of the next operation. Here, a time period from a current time point to the scheduled next operation start time is an example of a first time.

When a mobile object 2 is periodically operated, the information of the next operation schedule of the mobile object 2 is acquired from a predetermined database for managing the periodic operation. When a mobile object 2 is non-periodically operated, the mobile object 2 is used in a sharing service, a rental service, or the like. Therefore, the information of the next operation schedule of the mobile object 2 is acquired from reservation information or the like in the sharing service, the rental service, or the like. The information of the next operation schedule is an example of schedule information of the mobile object 2 which is a predetermined device. Accordingly, the control center 4 can be said to acquire the first time based on the schedule information of the mobile object 2 which is a predetermined device.

Then, the control center 4 acquires a current state of charge (SOC) of a battery. The current state of charge (SOC) of the battery can be said to be a residual capacity of the battery. The control center 4 calculates an amount of consumed electric power in each process which is performed in the mobile object 2. The control center 4 calculates a required amount of electric power from the residual capacity of the battery and the amount of consumed electric power in each process (S33). In the flow of processes illustrated in FIG. 7, the amount of consumed electric power in each process includes an amount of consumed electric power for downloading, an amount of consumed electric power for updating, and an amount of consumed electric power for operation.

The amount of consumed electric power for downloading is an amount of consumed electric power when the mobile object 2 downloads update data of a computer program from the vehicle management center 3. The amount of consumed electric power for downloading is calculated from a download power consumption rate illustrated in FIG. 5 based on the data size of the update data. For example, when the data size of the update data is 20 MB and the download power consumption rate is 10%/10 MB, 20% of an amount of electric power in a fully charged state of the battery is consumed. The amount of consumed electric power for downloading is defined as a third amount of consumed electric power.

The amount of consumed electric power for updating is an amount of consumed electric power when each ECU of the mobile object 2 updates a computer program to be updated. The amount of consumed electric power for updating is calculated from an update power consumption rate illustrated in FIG. 5 based on the data size of the update data. For example, when the data size of the update data is 20 MB and the update power consumption rate is 10%/10 MB, 20% of an amount of electric power in the fully charged state of the battery is consumed. The amount of consumed electric power for updating is defined as a second amount of consumed electric power.

The amount of consumed electric power for operation is an amount of consumed electric power when the mobile object 2 is operated as scheduled. For example, when an operation time is 1 hour and an operation power consumption rate is 50%/h, 50% of an amount of electric power in the fully charged state of the battery is consumed. The amount of consumed electric power for operation is defined as a first amount of consumed electric power.

Then, the control center 4 calculates a required amount of charged electric power from the current state of charge (residual capacity) of the mobile object 2 and the amounts of electric power consumed in the processes. For example, when the amount of consumed electric power for downloading is 20%, the amount of consumed electric power for updating is 20%, and the amount of consumed electric power for operation assumed based on an operation schedule is 50%, the battery needs to be charged until the residual capacity reaches at least 90% of the state of charge in the fully charged state. Accordingly, for example, when the current state of charge of the battery is 5% of the state of charge in the fully charged state, the required amount of charged electric power is calculated as 90%-5%=85%. In this embodiment, the required amount of charged electric power is defined as a first amount of charged electric power.

As described above, the control center 4 can be said to perform the process of S33 which is an example of acquisition of a first amount of charged electric power required for a battery that operates a predetermined device. Accordingly, the control center 4 can be said to acquire the first amount of charged electric power based on the third amount of consumed electric power for downloading in addition to the first amount of consumed electric power for operation and the second amount of consumed electric power for updating in the process of S33. When the mobile object 2 downloads update data in advance, the amount of consumed electric power for downloading may not be included in S33. In this case, the control center 4 acquires the first amount of charged electric power from the current residual capacity of the battery, the first amount of consumed electric power of the battery scheduled to be consumed in operation for a predetermined time, and the second amount of consumed electric power scheduled to be consumed in updating at least the first program. The process of S33 can be said to be an example of acquisition of the first amount of charged electric power from the current residual capacity of the battery and the first amount of consumed electric power of the battery scheduled to be consumed in operation for a predetermined time of the mobile object 2. This is because the first amount of charged electric power required for the battery is acquired based on at least the first amount of consumed electric power for operation in calculation of S33.

Then, the control center 4 calculates required times for regular charging and quick charging from the required amount of charged electric power (S34). The required times for regular charging and quick charging can be acquired by dividing the required amount of charged electric power by the regular charging rate and the quick charging rate illustrated in FIG. 5. Then, the control center 4 determines whether regular charging is right for a next operation time (S35). When it is determined in S35 that charging can be completed by regular charging until the next operation time, the control center 4 makes a plan for regular charging and updating and adds the plan to the operation schedule (S36). On the other hand, when it is determined in S35 that charging cannot be completed by regular charging until the next operation time, the control center 4 determines whether quick charging is right for the next operation time (S37). When it is determined in S37 that charging can be completed by quick charging until the next operation time, the control center 4 makes a plan for quick charging and updating and adds the plan to the operation schedule (S38).

On the other hand, when it is determined in S37 that charging cannot be completed by quick charging until the next operation time, the control center 4 performs a process of planning a next operation schedule without an update (S39). An example of the process of planning a next operation schedule without an update is illustrated in FIG. 8. A time period to the next operation time is an example of a period of a first time. Accordingly, the control center 4 can be said to perform the determinations of S35 and S37 as an example of selecting a charging method that enables charging with the first amount of charged electric power calculated in the process of S33 in the period of the first time out of a plurality of charging methods. The control center 4 can be said to perform the processes of S36 and S38 as an example of making a first plan including charging with at least the first amount of charged electric power of the battery using the selected charging method and updating of at least the first program (a program group which is rewritten by this updating).

FIG. 8 is a flowchart illustrating details of the process of planning a next operation schedule without an update of a computer program in a mobile object 2. That is, FIG. 8 illustrates details of the process of planning a next operation schedule without an update (S4 in FIG. 6 and S39 in FIG. 6). The processes of S42 to S48 in FIG. 8 are the same as the processes of S32 to S38 in FIG. 7 except that the amount of consumed electric power for downloading and the amount of consumed electric power for updating are not calculated. Therefore, details of the processes of S42 to S48 will not be repeatedly described. In the process of S43, the control center 4 calculates an amount of consumed electric power for operation of the mobile object 2. As described above with reference to FIG. 7, the amount of consumed electric power for operation of the mobile object 2 is an example of the first amount of consumed electric power of the battery scheduled to be consumed in operation for a predetermined time of a predetermined device. Accordingly, the computer of the control center 4 can be said to acquire the first amount of charged electric power from the residual capacity of the battery which is a current state of charge of the battery and the first amount of consumed electric power of the battery scheduled to be consumed in operation for a predetermined time of the mobile object 2.

In the process of planning a next operation schedule without an update, when it is determined that charging cannot be completed by regular charging and quick charging until the next operation time (NO in S47), the control center 4 requests an operator to adjust the next operation schedule (S49). For example, the control center 4 estimates a time point at which charging with the required amount of charged electric power is completed by quick charging and presents the estimated time point to the operator. When the operator inputs confirmation, the control center 4 can set the time point at which charging with the required amount of charged electric power is completed as a new next operation start time.

### Advantages of Embodiment

As described above, the information system 100 including the control center 4 according to this embodiment acquires a minimum state of charge required for operation of the mobile object 2. The, the information system 100 can select a charging method that enables charging from a current state of charge to a minimum state of charge required for operation of the mobile object 2 until the next operation start time out of a plurality of charging methods. Accordingly, the information system 100 according to this embodiment can appropriately set an operation schedule of a mobile object 2 which repeatedly performs operation and charging.

When the mobile object 2 is periodically operated, the information system 100 acquires a next operation start time from a predetermined database that manages the periodic operation. When the mobile object 2 is non-periodically operated, the computer acquires information of a next operation schedule of the mobile object 2 from reservation information in a sharing service, a rental service, or the like. Accordingly, the information system 100 can appropriately acquire a next operation start time according to a service in which the mobile object 2 is used.

The information system 100 calculates a required amount of charged electric power from the current state of charge of the mobile object 2 and an amount of electric power consumed in each process with operation of the mobile object. Accordingly, the information system 100 can accurately calculate the required amount of electric power for the mobile object 2. In this case, the information system 100 can accurately calculate a required amount of electric power for operation of the mobile object 2, downloading of update data of a computer program for each ECU in the mobile object 2, and updating of the computer program.

The information system 100 can calculate a charging time required for charging with the required amount of electric power and establish a plan for performing charging of the battery of the mobile object 2 and updating of a computer program of each ECU in the mobile object 2 until a next operation start time of the mobile object 2.

When charging with the required amount of electric power is not completed until the scheduled next operation time, the information system 100 estimates a time at which charging with the required amount of electric power is completed and changes the next operation start time to the time at which charging is completed after confirmation from an operation has been received. Accordingly, the information system 100 can make a plan such that a time period up to operation start is equal to or greater than at least the charging time.

The information system additionally considers an amount of electric power for downloading in the required amount of electric power. Accordingly, the information system can calculate the required amount of electric power in consideration of downloading of data required for updating a computer program.

### Second Embodiment

In the first embodiment, the control center 4 planned a next operation schedule without updating a computer program of the mobile object 2 when charging with the required amount of charged electric power cannot be completed by quick charging. In this embodiment, an example in which, when charging cannot be completed by quick charging, the control center 4 performs a process of planning a next operation schedule such that updating of a computer program can be performed will be described.

The first embodiment is based on the premise that downloading of update data for updating and updating of a computer program for each ECU in the mobile object 2 are completed while the battery of the mobile object 2 is being charged. In this embodiment, a process of planning a next operation schedule such that downloading of update data for updating and updating of a computer program for each ECU in the mobile object 2 can be completed when the downloading and the updating cannot be completed while the battery of the mobile object 2 is being charged will be described. The configuration and the operations of the information system 100 according to the second embodiment except for the aforementioned points are the same as in the first embodiment. Accordingly, FIGS. 1 to 6 in the first embodiment are employed by the second embodiment without any change.

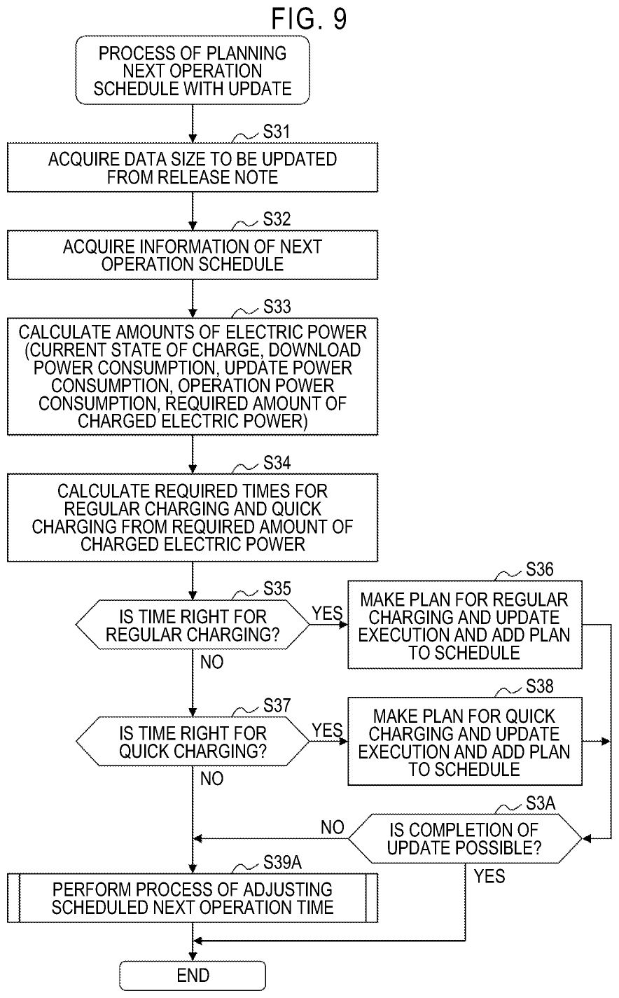

FIG. 9 is a flowchart illustrating details of a process of planning a next operation schedule with an update (S3 in FIG. 6) according to the second embodiment. In FIG. 9, the processes of S31 to S38 are the same as illustrated in FIG. 7 and thus description thereof will be omitted.

In FIG. 9, when it is determined in S37 that charging is not completed by quick charging until the scheduled next operation time, the control center 4 performs a process of adjusting the scheduled next operation time (S39A). The control center 4 performs determination of S3A after the process of making a plan for regular charging and updating and adding the plan to the operation schedule in S36 and the process of making a plan for quick charging and updating and adding the plan to the operation schedule in S38 have been performed. Then, the control center 4 determines whether a computer program for each ECU in the mobile object 2 can be updated while charging is being performed (S3A). The determination of whether a computer program can be updated may include determination of whether downloading of update data and updating of a computer program after the date data has been downloaded are possible. In this embodiment, updating of a computer program not including downloading of update data is referred to as rewriting of a computer program.

In the process of S34 which is performed before the determination of S3A, the control center 4 acquires a time required for rewriting a program based on a data size of update data which is used to update the program. In this embodiment, the time required for updating a program not including downloading thereof is referred to as a second time. In the process of S34, the control center 4 acquires a time required for downloading update data for the program. In this embodiment, the time required for downloading update data is referred to as a third time.

When it is determined in S3A that updating cannot be completed while charging is being performed, the control center 4 performs the process of adjusting the scheduled next operation time (S39A). The operation schedule which is prepared in the adjustment process of S39A is referred to as a first plan. Accordingly, the control center 4 can be said to make the first plan such that the time to start of use of a mobile object 2 which is an example of a predetermined device is equal to or greater than the sum of at least the second time and the third time. On the other hand, when it is determined in S3A that updating can be completed while charging is being performed, the control center 4 ends the flow of processes.

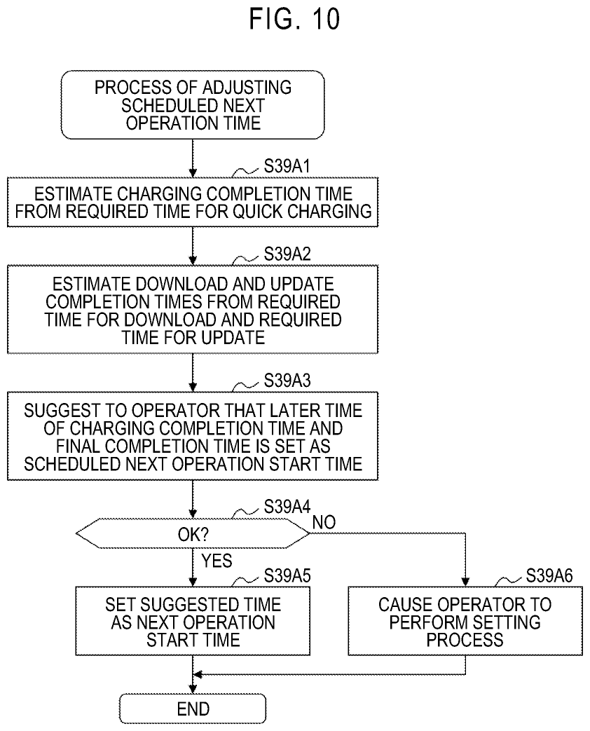

FIG. 10 is a diagram illustrating details of the process of adjusting a scheduled next operation time (S39A in FIG. 9). In this process, the control center 4 estimates a charging completion time from a required time for quick charging (S39A1). The control center 4 estimates completion times of downloading and updating from a required time for updating (the second time) and a required time for downloading update data (the third time) (S39A2). As described above, the required time for updating (the second time) and the required time for downloading update data (the third time) are calculated in advance in the process of S34 in FIG. 9.

Then, the control center 4 notifies an operator that the later time of the charging completion time and the completion time of downloading and updating is to be set as a next operation start time using a display device (S39A3). Then, the control center 4 waits for an input of OK from the operator (S39A4). When an input of OK is received in S39A4, the control center 4 sets the notified time as the next operation start time and plans the operation schedule of the mobile object 2 (S39A4). As described above, the control center 4 performs the processes of S39A1 to S39A4 as an example of the process of preparing the first plan such that the time to start of use is equal to or greater than the sum of at least the second time and the third time. Thereafter, the control center 4 ends the flow of processes.

On the other hand, when an input of OK is not received in S39A4, the control center 4 allows an operator to perform an operation schedule setting process (S39A6). That is, the control center 4 requests the operator to set an appropriate operation schedule of the mobile object 2. After the operator has set the operation schedule, the control center 4 ends the flow of processes. Here, the time period from a current time point to the next operation start time is an example of the first time.

In FIG. 10, the control center 4 notifies an operator that the later time of the charging completion time and the completion time of downloading and updating is to be set as a next operation start time. That is, in FIG. 10, the next operation start time is determined in consideration of a time point at which updating of a computer program has completed in addition to the time required for downloading update data. However, downloading of update data can also be performed in advance before the computer program is rewritten. Therefore, the control center 4 may determine the next operation start time such that updating including only rewriting of a computer program is completed without considering the time required for downloading update data.

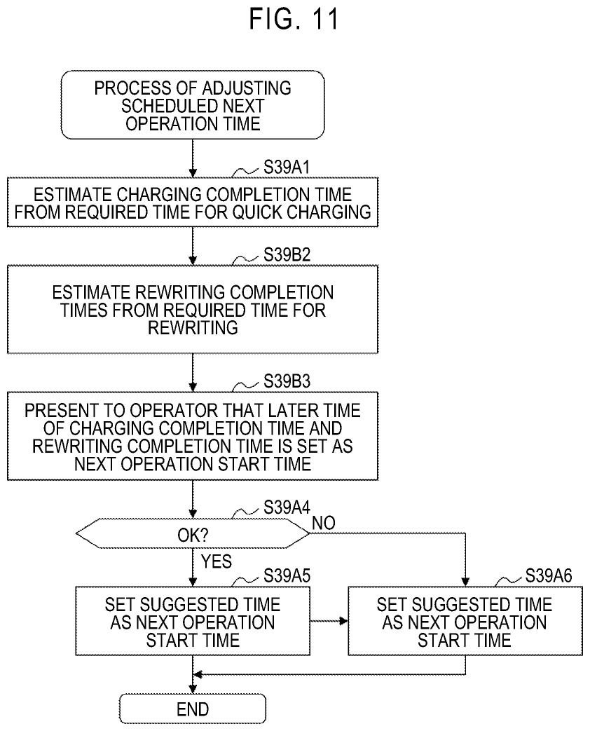

FIG. 11 is a diagram illustrating a detailed modification of the process of adjusting a scheduled next operation time (S39A in FIG. 9). As the premise that the flow of processes illustrated in FIG. 11 is performed, in the determination of S3A in FIG. 9, the control center 4 can determine whether rewriting of a computer program after the update data has been downloaded is possible without considering a time required for downloading update data. In this case, the control center 4 does not consider the time required for downloading update data. Accordingly, the control center 4 can be said to acquire a time required for rewriting the first program as the second time in the determination of S3A in FIG. 9.

The process of S39A1 in FIG. 11 is the same as in FIG. 10 and thus description thereof will be omitted. Then, the control center 4 estimates a completion time of updating (that is, rewriting of a computer program) from a time (the second time) required for rewriting a computer program for each ECU in the mobile object 2 (S39B2). The control center 4 notifies an operator that the later time of a charging completion time and an updating (rewriting) completion time is to be set as a next operation start time (S39B3). The processes of S39A4 and steps subsequent thereto in FIG. 11 are the same as in FIG. 10 and thus description thereof will be omitted. The processes of S39A1 to S39A6 are an example of preparing the first plan such that a time to start of use of the mobile object 2 which is an example of a predetermined device is equal to or greater than the second time.

### Advantages of Second Embodiment

According to this embodiment, the information system 100 can set an operation schedule such that charging of a battery in a mobile object 2 is completed up to a next operation start time. According to the flow of processes illustrated in FIG. 10, the information system 100 can set the operation schedule such that downloading of update data and updating of a computer program for each ECU in the mobile object 2 are completed up to the next operation start time. According to the flow of processes illustrated in FIG. 11, the information system can set the operation schedule such that updating (rewriting) of a computer program for each ECU in the mobile object 2 is completed up to the next operation start time.

### Third Embodiment

In the first embodiment and the second embodiment, a process of planning an operation schedule including updating a computer program which is executed by each ECU in a mobile object 2 and charging a battery of the mobile object 2 has been described above. The processes in the first embodiment and the second embodiment can be applied to a device other than the mobile object 2, for example, a portable electronic device such as a mobile phone or a smartphone. Therefore, in this embodiment, a configuration and a process of preparing an operation plan including updating a computer program which is executed by a portable electronic device and charging of a battery which is mounted in the portable electronic device will be described.

Example of Configuration

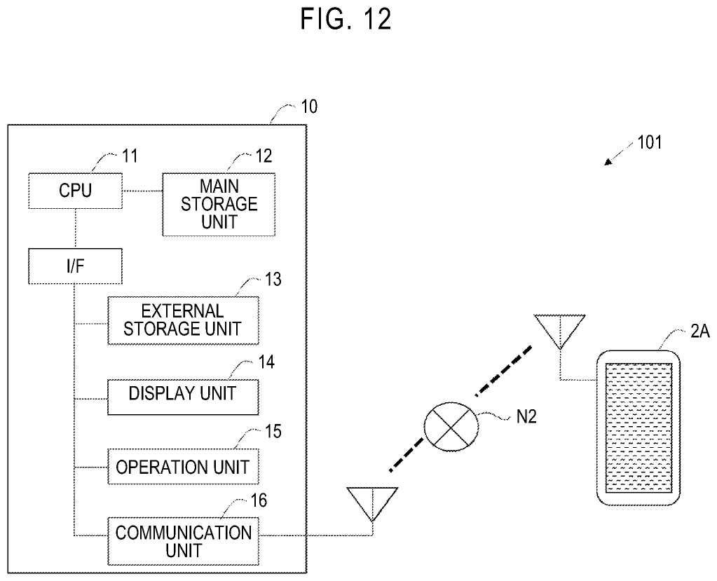

FIG. 12 is a diagram illustrating a configuration of an information system 101 according to the third embodiment. The information system 101 includes a computer 10 and a portable electronic device 2A. The computer 10 is also referred to as a server. The computer 10 includes a terminal that can wirelessly communicate with the portable electronic device 2A. The computer 10 includes a CPU 11, a main storage unit 12, and an external device connected thereto via an interface (I/F), and performs information processing using a computer program. The CPU 11 is also referred to as a processor. The CPU 11 is not limited to a single processor, but may have a configuration of multiple processors. The CPU 11 may include a graphics processing unit (GPU) and a digital signal processor (DSP). The CPU 11 may be combined with a hardware circuit such as a field-programmable gate array (FPGA). Examples of the external device include an external storage unit 13, a display unit 14, an operation unit 15, and a communication unit 16.

The CPU 11 executes a computer program which is executably loaded onto the main storage unit 12 and provides functions of the computer 10. The main storage unit 12 stores a computer program which is executed by the CPU 11, data which is processed by the CPU 11, and the like. The main storage unit 12 is a dynamic random access memory (DRAM), a static random access memory (SRAM), or a read only memory (ROM). The external storage unit 13 is used, for example, as a storage area for assisting with the main storage unit 12 and stores a computer program which is executed by the CPU 11, data which is processed by the CPU 11, and the like. The external storage unit 13 is a hard disk drive, a solid state disk (SSD), or the like. A drive device for a removable storage medium may be provided in the computer 10. The removable storage medium may be, for example, a Blu-ray disk, a digital versatile disk (DVD), a compact disc (CD), or a flash memory card.

The computer 10 includes a display unit 14, an operation unit 15, and a communication unit 16. The display unit 14 is, for example, a liquid crystal display or an electroluminescence panel. The operation unit 15 includes, for example, a keyboard and a pointing device. In this embodiment, a mouse is exemplified as the pointing device. The communication unit 16 transmits and receives data to and from another device over a network. For example, the communication unit 16 communicates with the portable electronic device 2A via a network N2. The network N2 is, for example, a mobile phone network such as LTE, 5G, or 6G or a wireless local area network (LAN). The communication unit 16 may include a communication interface that can access the network N in the first embodiment (FIG. 1).

The portable electronic device 2A has the same configuration as the computer 10. Here, the portable electronic device 2A includes a touch panel in which a touch sensor is superimposed on a display as an operation unit. The hardware configuration of the computer of the vehicle management center 3 and the computer of the control center 4 described above in the first embodiment and the second embodiment is the same as the computer 10. Each ECU described above in the first embodiment and the second embodiment is the same as a combination of the CPU 11 and the main storage unit 12 in FIG. 12. Accordingly, in the first to third embodiments, the CPU 11 and the main storage unit 12 are described as an example of a control unit.

The computer 10 performs the same processes as the vehicle management center 3 and the control center 4 in the first embodiment and the second embodiment. That is, the computer 10 supports charging of a battery of the portable electronic device 2A, updating a computer program which is executed by the CPU 11, and use of the portable electronic device 2A by a user. For example, the computer 10 accesses a schedule management database which is provided to a user via the portable electronic device 2A and acquires a schedule of the user.

The schedule management database may be stored in the main storage unit 12 and the external storage unit 13 of the computer 10. The portable electronic device 2A can access the computer 10 via the network N2 and provide the function of the schedule management database to the user. The schedule management database may be stored in the portable electronic device 2A. When the schedule management database is stored in the portable electronic device 2A, the computer 10 can collect information of the schedule management database from the portable electronic device 2A under the confirmation of the user.

A time period (a candidate time period for updating) in which a user does not operate the portable electronic device 2A may be set in advance in the schedule management database. The candidate time period for updating may be set by a user. The portable electronic device 2A or the computer 10 may statistically process operation histories of the user and select a day, a time period, or the like in which the portable electronic device 2A is least likely to be operated. The portable electronic device 2A or the computer 10 may present the selected day, time period, or the like to a user via a display of the portable electronic device 2A and request confirmation to the user in advance.

The computer 10 prepares an operation schedule including charging of a battery, downloading of update data, and updating of a computer program which is executed by the CPU 11 in the time period in which the user does not use the portable electronic device 2A. The prepared operation schedule of the portable electronic device 2A is transmitted to the portable electronic device 2A. The portable electronic device 2A performs charging of the battery, downloading of update data, and updating of a computer program which is executed by the CPU 11 based on the transmitted operation schedule.

### Processing Example

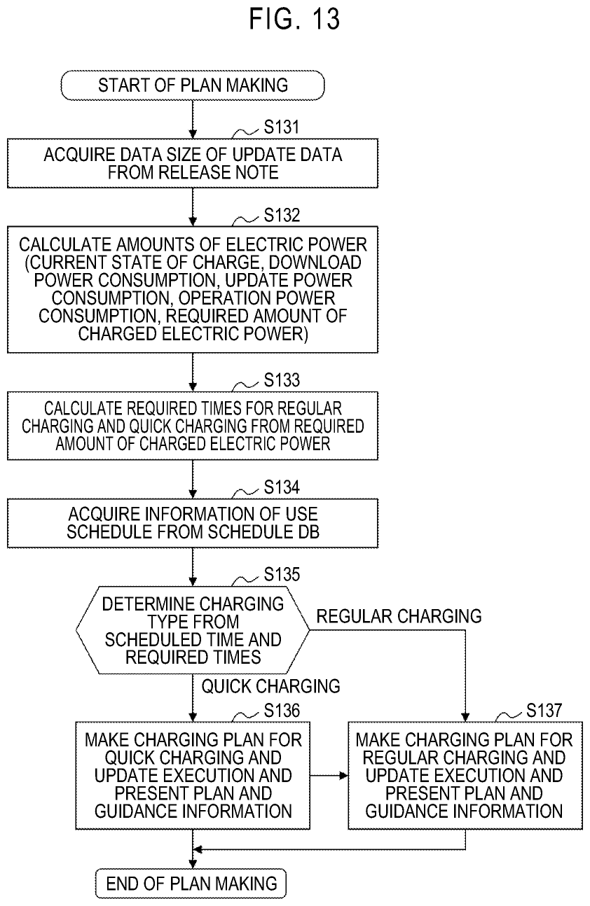

FIG. 13 is a diagram illustrating a process of preparing a plan for updating a computer program which is executed in the portable electronic device 2A, and which is performed by the computer 10. The flow of processes illustrated in FIG. 13 is performed when the portable electronic device 2A can perform updating a computer program. The computer 10 may determine that updating of a computer program in the portable electronic device 2A can be performed from the schedule management database of the user. The computer 10 may determine that updating of a computer program can be performed based on an operation input of the user to the portable electronic device 2A.

First, in this flow of processes, the computer 10 acquires a data size of update data from a release note of a program which is executed by the portable electronic device 2A (S131). When the computer 10 is operated in an organization for selling the portable electronic device 2A or an organization for providing a service such as communication to the portable electronic device 2A, the computer 10 stores a release note. The computer 10 may acquire the release note from the organization for selling the portable electronic device 2A or the like via the network N in the first embodiment, the network N2 in the third embodiment, or the like.

Then, the computer 10 calculates an amount of consumed electric power in each process which is performed by the portable electronic device 2A (S132). The amount of consumed electric power in each process includes an amount of consumed electric power for downloading, an amount of consumed electric power for updating, and an amount of consumed electric power for operation. The amount of consumed electric power for downloading and the amount of consumed electric power for updating are the same as those in the first embodiment and the second embodiment.

The amount of consumed electric power for operation is an amount of consumed electric power when the portable electronic device 2A is activated and performs information processing. The amount of consumed electric power for operation may be statistically calculated from an operation history in the past of the portable electronic device 2A. The computer 10 calculates a required amount of charged electric power from a current state of charge of the portable electronic device 2A and the amounts of consumed electric power in the processes.

Then, the computer 10 calculates required times for regular charging and quick charging from the required amount of charged electric power (S133). The computer 10 acquire information of a use schedule of the portable electronic device 2A from the schedule management database of the user (S134). The information on a use schedule includes a scheduled use start time, a use duration time, and a type of a process to be performed. A time period to the scheduled use start time is a time period to a next start of use and is an example of the first time. Accordingly, the computer 10 performs the process of S133 which is an example of the process of acquiring the information based on schedule information of a user of the portable electronic device 2A which is an example of a predetermined device. The computer 10 may acquire information of a use schedule through a user's operation input to the portable electronic device 2A.

The computer 10 determines which of regular charging and quick charging is required from the scheduled use start time and the required times for regular charging and quick charging (S135). For example, when charging with the required amount of charged electric power up to the scheduled use start time is possible by regular charging, the computer 10 selects regular charging. On the other hand, when charging with the required amount of charged electric power up to the scheduled use start time is not possible by regular charging, the computer 10 select quick charging.

When quick charging is selected, the computer 10 prepares a charging plan for quick charging and updating and presents the plan and guidance information to a display of the portable electronic device 2A (S136). When regular charging is selected, the computer 10 prepares a charging plan for regular charging and updating and presents the plan and guidance information to the display of the portable electronic device 2A (S137). When one of S136 and S137 is presented to the display of the portable electronic device 2A, the user can perform charging of the portable electronic device 2A and updating of the computer program based on the presentation to the display.

As described above, with the information system 101 according to this embodiment, the computer 10 supports updating of a computer program in the portable electronic device 2A and charging of the portable electronic device 2A with a required amount of charged electric power. That is, the computer 10 can perform regular charging such that charging with the required amount of charged electric power is completed up to the scheduled use start time. When charging of the portable electronic device 2A with the required amount of charged electric power cannot be completed up to the scheduled use start time, the computer 10 can promote charging with the required amount of charged electric power while a computer program is being updated by prompting the user to select quick charging.

### Other Modified Examples

In the first embodiment and the second embodiment, the computer of the control center 4 performs the process of setting an operation schedule of a mobile object 2 (FIGS. 6 to 11). However, the central ECU 22 which is an onboard device of the mobile object 2 may perform the process. In this case, the vehicle management center 3 can transmit a release note to the central ECU 22 via the DCM 21 of the mobile object 2.

In the third embodiment, the computer 10 performs the plan preparing process illustrated in FIG. 13. However, the portable electronic device 2A may perform the plan preparing process illustrated in FIG. 13 and present the plan to a user. In this case, the portable electronic device 2A can receive a release note transmitted from a computer of an organization for managing the release note, for example, the computer 10, and update data of a computer program provided therefrom.

### Other Embodiments

The aforementioned embodiments are merely an example and the present disclosure can be appropriately modified without departing from the gist thereof. Processes or means described in the present disclosure can be freely combined unless technical conflictions arise.

A process which has been described to be performed by a single device may be divisionally performed by two or more devices. Alternatively, processes which have been described to be performed by different devices may be performed by a single device. In a computer system, by what hardware configuration (server configuration) each function is realized can be flexibly changed.

The present disclosure can also be realized by supplying a computer program in which the functions described above in the embodiment are mounted to a computer and causing one or more processors of the computer to read and execute the program. This computer program may be provided to the computer using a non-transitory computer-readable storage medium which can be connected to a system bus of the computer or may be provided to the computer via a network. For example, the non-transitory computer-readable storage medium includes an arbitrary type of disk such as a magnetic disk (a floppy (registered trademark) disk or a hard disk drive (HDD)) or an optical disc (such as a CD-ROM, a DVD disc, or a Blu-ray disc) or an arbitrary type of media suitable for storing electronic commands such as a read only memory (ROM), a random access memory (RAM), an erasable programmable ROM (EPROM), an electrically erasable programmable ROM (EEPROM), a magnetic card, a flash memory, or an optical card.

What is claimed is:

1. An information processing device comprising a control unit configured to perform:
acquiring a first amount of charged electric power required for a battery that operates a predetermined device; and
selecting a charging method enabling charging with at least the first amount of charged electric power in a period of a first time out of a plurality of charging methods.

2. The information processing device according to claim 1, wherein the control unit is configured to perform acquiring the first time based on schedule information of the predetermined device or schedule information of a user of the predetermined device.

3. The information processing device according to claim 1, wherein the control unit is configured to perform acquiring the first amount of charged electric power from a current residual capacity of the battery and a first amount of consumed electric power of the battery which is scheduled to be consumed in operating the predetermined device in a predetermined time.

4. The information processing device according to claim 1, wherein the control unit is configured to further perform:
acquiring information on updating of a first program mounted in the predetermined device, the information including a data volume of update data used to update the first program;
acquiring the first amount of charged electric power based on the information on updating of the first program; and
making a first plan including charging of the battery with at least the first amount of charged electric power based on the selected charging method and at least updating of the first program.

5. The information processing device according to claim 4, wherein the control unit is configured to perform acquiring the first amount of charged electric power from the current residual capacity of the battery, a first amount of consumed electric power of the battery which is scheduled to be consumed in operating the predetermined device in a predetermined time, and a second amount of consumed electric power of the battery which is scheduled to be consumed in updating at least the first program.

6. The information processing device according to claim 5, wherein the first plan additionally includes downloading update data of the first program, and
wherein the control unit is configured to perform acquiring the first amount of charged electric power based on a third amount of consumed electric power of the battery which is scheduled to be consumed in downloading the update data of the first program in addition to the first amount of consumed electric power and the second amount of consumed electric power.

7. The information processing device according to claim 4, wherein the first time is a time up to next start of use of the predetermined device, and
wherein the control unit is configured to further perform:
acquiring a second time required for updating the first program based on a data volume of update data used to update the first program; and
making the first plan such that the time up to the next start of use of the predetermined device is equal to or greater than the second time.

8. The information processing device according to claim 7, wherein the control unit is configured to further perform:
acquiring a third time required for downloading update data of the first program based on a data volume of update data used to update the first program; and
making the first plan such that the time up to the next start of use of the predetermined device is equal to or greater than a sum of the second time and the third time.

9. The information processing device according to claim 4, wherein the predetermined device is a vehicle that is able to travel autonomously,
wherein the information processing device is a server that communicates with the vehicle, and
wherein the control unit is configured to perform transmitting the first plan to the vehicle.

10. The information processing device according to claim 4, wherein the predetermined device is a vehicle that is able to travel autonomously, and
wherein the information processing device is a computer that is mounted in the vehicle.

11. The information processing device according to claim 4, wherein the predetermined device is a portable terminal,
wherein the information processing device is a server that communicates with the terminal, and
wherein the control unit is configured to perform transmitting the first plan to the terminal.

12. An information processing method that is performed by a computer, the information processing method comprising:
acquiring a first amount of charged electric power required for a battery that operates a predetermined device; and
selecting a charging method enabling charging with at least the first amount of charged electric power in a period of a first time out of a plurality of charging methods.

13. The information processing method according to claim 12, wherein the computer is configured to perform acquiring the first time based on schedule information of the predetermined device or schedule information of a user of the predetermined device.

14. The information processing method according to claim 12, wherein the computer is configured to perform acquiring the first amount of charged electric power from a current residual capacity of the battery and a first amount of consumed electric power of the battery which is scheduled to be consumed in operating the predetermined device in a predetermined time.

15. The information processing method according to claim 12, wherein the computer is configured to further perform:
acquiring information on updating of a first program mounted in the predetermined device, the information including a data volume of update data used to update the first program;
acquiring the first amount of charged electric power based on the information on updating of the first program; and
making a first plan including charging of the battery with at least the first amount of charged electric power based on the selected charging method and at least updating of the first program.

16. The information processing method according to claim 15, wherein the computer is configured to perform acquiring the first amount of charged electric power from the current residual capacity of the battery, a first amount of consumed electric power of the battery which is scheduled to be consumed in operating the predetermined device in a predetermined time, and a second amount of consumed electric power of the battery which is scheduled to be consumed in updating at least the first program.

17. The information processing method according to claim 16, wherein the first plan additionally includes downloading update data of the first program, and
wherein the computer is configured to perform acquiring the first amount of charged electric power based on a third amount of consumed electric power of the battery which is scheduled to be consumed in downloading the update data of the first program in addition to the first amount of consumed electric power and the second amount of consumed electric power.

18. The information processing method according to according to claim 15, wherein the first time is a time up to next start of use of the predetermined device, and
wherein the computer is configured to further perform:
acquiring a second time required for updating the first program based on a data volume of update data used to update the first program; and
making the first plan such that the time up to the next start of use of the predetermined device is equal to or greater than the second time.

19. The information processing method according to claim 18, wherein the computer is configured to further perform:
acquiring a third time required for downloading the first program based on a data volume of update data used to update the first program; and
making the first plan such that the time up to the start of use of the predetermined device is equal to or greater than a sum of the second time and the third time.

20. An information system comprising:
an information processing device including a control unit configured to perform:
acquiring a first amount of charged electric power required for a battery that operates a predetermined device; and
selecting a charging method enabling charging with at least the first amount of charged electric power in a period of a first time out of a plurality of charging methods; and
the predetermined device.
